(19) United States
(12) Patent Application Publication
(10) Pub. No.: US 2011/0167587 A1
(43) Pub. Date: Jul. 14, 2011

(54) Method of Manufacturing Composite Bushing Substrate

(76) Inventors: Harry Shimp, Chagrin Falls, OH (US); Bob Bochman, Higganum, CT (US); Moe Rahamat, Wolcott, CT (US)

(21) Appl. No.: 12/699,510

(22) Filed: Feb. 3, 2010

Related U.S. Application Data
(60) Provisional application No. 61/149,540, filed on Feb. 3, 2009.

(51) Int. Cl. F16L 5/00; B21D 31/00

(52) U.S. Cl. 16/2.1; 72/377

(57) ABSTRACT

A composite bushing substrate and method of producing the same are provided. The composite bushing substrate may include a clad metal, created by metallically bonding a high strength base layer and an interlayer. The surface of the interlayer may be textured or embossed to form a surface with a high surface area. A low friction surface material may be applied to the textured interlayer surface, resulting in a composite bushing material that can resist deformation of the surface material.

### PRIORITY

The present application claims priority to U.S. Provisional Patent Application Serial No. 61/149,540, filed on Feb. 3, 2009, which is incorporated herein in its entirety by reference.

### BACKGROUND

The present application relates generally to a composite bushing substrate and a method of manufacturing the composite bushing substrate. In particular, the application subject matter provides a composite bushing substrate including a textured surface that provides increased surface area for the bonding of a covering layer surface material.

Bushings may act as seals and/or low friction support surfaces between mechanical parts with relative movement. A common example of a bushing is a cylindrical lining of a hole or sleeve that supports a mating, movable shaft. Historically, bushings were constructed of a single material such as bronze, graphite, or oakum. Modern bushings may also be made of a single material, like polytetrafluoroethylene (PTFE), but are frequently built in a composite fashion to improve performance properties such as resistance to deformation, resistance to wear, and lubricity.

Composite bushing designs may include a substrate base layer for providing mechanical strength and support, and a surface material layer for providing lubricity. Depending on the severity of the application, a composite bushing substrate may include a solid or matrix intermediate layer to improve the joining of the surface material layer to the substrate base layer. The intermediate layer or interlayer may also improve the performance and longevity of the surface material.

In high load applications, a common bushing failure mode is for the low friction surface material to get “squeezed” out of place when supporting the load from a mating part. The mating part may then come into direct contact with the bushing substrate, resulting in increased wear, galling, or seizure. In order to reduce the “squeezing out” or deformation of the surface material, composite bushings may utilize a matrix interlayer, which may be made of a low friction metal (often bronze) and bonded to the substrate base layer to form the substrate. By its shape, the matrix interlayer helps to hold the surface material in place to reduce deformation.

Expanded metal, which can be adhesively bonded to the substrate's base layer, is a commonly used matrix interlayer when bushing operating temperatures are not high. In elevated temperature environments, another common matrix interlayer is a layer of small bronze spheres which are metallically bonded to the substrate base layer's surface. Both designs result in a non-flat or textured substrate surface, providing an extended z-dimension with increased surface area to bind to the surface material and to resist deformation in the x-y plane.

### BRIEF DESCRIPTION OF THE DRAWINGS

FIG. 1A is a cross section drawing of layers of an exemplary composite bushing;

FIG. 1B is a cross section drawing of layers of an exemplary composite bushing, including an interlayer;

FIG. 2A is a cross section drawing of layers of an exemplary composite bushing, including a textured substrate base;

FIG. 2B is a cross section drawing of layers of an exemplary composite bushing, including a textured substrate interlayer;

FIG. 3A is a cross section drawing of layers of an exemplary composite bushing, illustrating perpendicular forces from a mating part;

FIG. 3B is a cross section drawing of layers of an exemplary composite bushing, illustrating tangential forces from a mating part;

FIG. 4 is a cross section drawing of layers of an exemplary cylindrical composite bushing and a mating shaft;

FIG. 5A is a cross section drawing of an exemplary textured bushing substrate interface surface;

FIG. 5B is another cross section drawing of an exemplary textured bushing substrate interface surface;

FIG. 5C is another cross section drawing of an exemplary textured bushing substrate interface surface;

FIG. 5D is another cross section drawing of an exemplary textured bushing substrate interface surface;

FIG. 6A is a cross section drawing of an exemplary interlayer with a surface material applied in an exemplary surface layer configuration;

FIG. 6B is another cross section drawing of an exemplary interlayer with a surface material applied in an exemplary surface layer configuration;

FIG. 6C is another cross section drawing of an exemplary interlayer with a surface material applied in an exemplary surface layer configuration;

FIG. 6D is another cross section drawing of an exemplary interlayer with a surface material applied in an exemplary surface layer configuration;

FIG. 7 is a block diagram of a method of manufacturing an exemplary composite bushing material;

FIG. 8A is an embodiment of a system to manufacture an exemplary composite bushing material;

FIG. 8B includes cross section drawings of exemplary material layers and configurations during progressive stages of the exemplary system of FIG. 8A; and

FIG. 9 is an illustration showing an exemplary textured roller forming an exemplary textured bushing substrate interface surface.

### DESCRIPTION

While the invention is described herein with specific reference to a variety of exemplary structural and material features, such descriptions are intended to be exemplary in nature and should not be construed in a limiting sense. Further, while various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred or exemplary arrangement or method, such description is not intended to suggest that such feature is required or necessary unless expressly so stated.

“Comprising,” “containing,” “having,” and “including,” as used herein, except where noted otherwise, are synonymous and open-ended. In other words, usage of any of these terms (or variants thereof) does not exclude one or more additional elements or method steps from being added in combination with one or more enumerated elements or method steps.

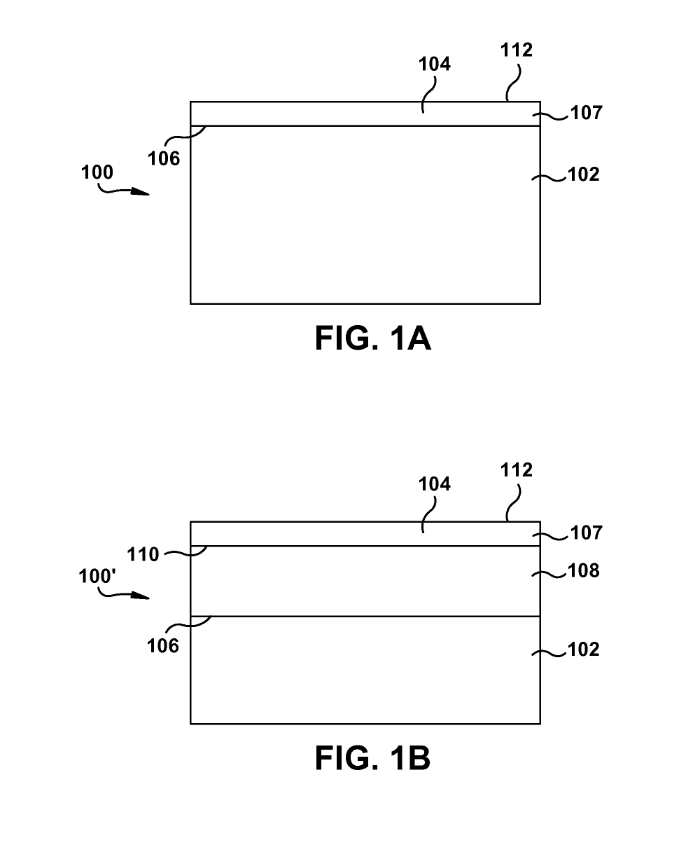

A cross section of an exemplary composite bushing material is shown in FIG. 1A. A bushing substrate 100 is shown as comprising a single base layer 102. The base layer 102 may be a high strength material, such as steel, to provide sufficient mechanical strength and support for the bushing application. A surface material 104 is shown applied to a surface 106 of the bushing substrate 100. The surface material 104 may be a low friction material, such as polytetrafluoroethylene (PTFE), that provides the lubricity and other properties sufficient for the bushing application. The surface material 104 may form a surface layer 107 having a contour 112 that flat or irregular. The surface layer 107 may also be deformable, depending on the bushing application.

Another cross section of an exemplary bushing substrate 100′ is shown in FIG. 1B including the base layer 102 and an intermediate layer or interlayer 108. A surface material 104 is shown applied to the bushing substrate 100′, on top of the interlayer 108. The interlayer 108 may provide improved joining of the base layer 102 to the surface material 104. The structure of the interlayer 108 may also improve the performance and longevity of the surface material 104 by holding the surface material 104 in place to prevent “squeeze out.” The surface material 104 is attached to the interlayer 108 along an interlayer surface 110.

The interlayer 108 may be a low-friction material, such as bronze, that is attached to the base layer 102. The interlayer 108 may be attached to the base layer 102 at the surface 106 using any suitable means. For example, the interlayer 108 may be metallically bonded to the base layer 102 using high pressure rollers, explosives, chemical deposition, electro-deposition, or the like, to form a clad material, such as a steel/bronze clad metal. In other embodiments, the interlayer 108 may be bonded to the base layer 102 using an adhesive or other bonding agent.

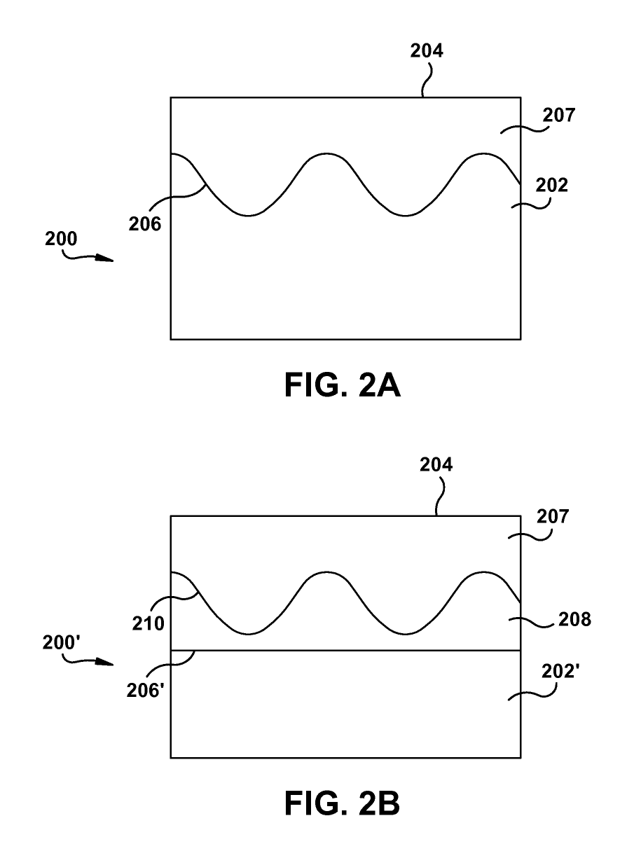

The ability of the surface material 104 to stay in place may increase as the total surface area and irregularity of the surface it is applied to increases. A base layer 202 of an exemplary single layer bushing substrate 200 is shown in FIG. 2A with an irregular or textured base surface 206. Similarly, an interlayer 208 of another exemplary bushing substrate 200′ is shown in FIG. 2B with an irregular or textured interlayer surface 210. A surface 206′ of a base layer 202′ is shown in FIG. 2B as being flat, not irregular or textured. Of course, an interlayer 208 may also be used in conjunction with an irregular or textured surface 206 of a base layer 202, although that is not shown in FIGS. 2A and 2B. Surface material 204 is also shown as a surface layer 207. Whatever layer of material the surface material 204 is applied to is the layer that may be textured to increase the joining strength and performance of the surface material 204. The pattern and relative dimensions of the textured base surface 206 and the textured interlayer surface 210 shown are exemplary for illustration purposes and in practice may be any configuration suitable for a bushing application.

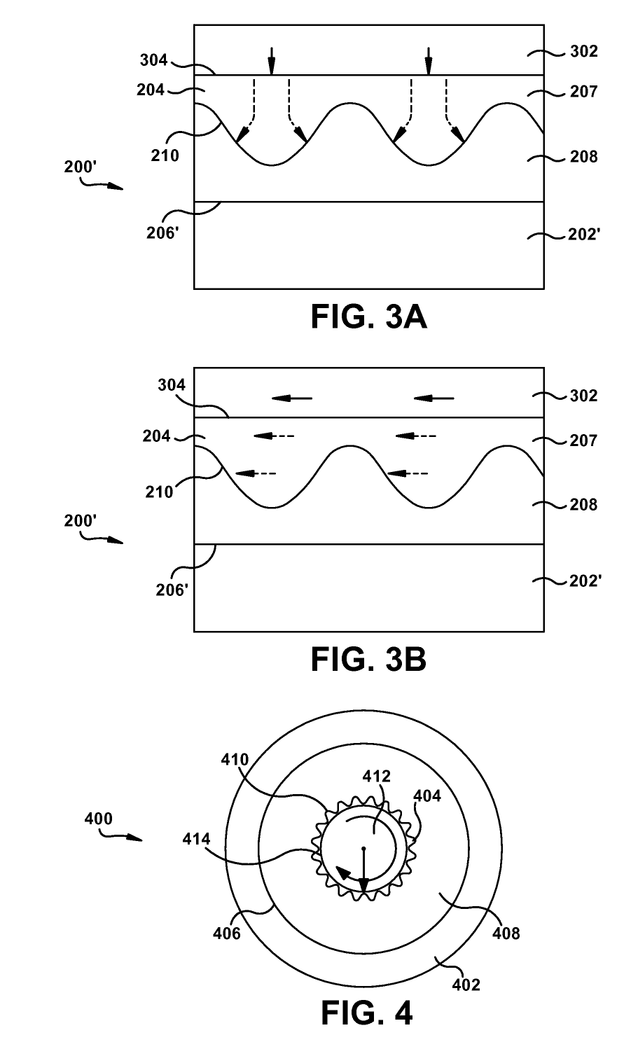

FIGS. 3A and 3B show the exemplary bushing substrate 200′, which includes the base layer 202′ and the interlayer 208. The surface material 204 of the surface layer 207 is shown applied to the textured interlayer surface 210 of the interlayer 208. FIGS. 3A and 3B also show an exemplary mating part 302. The mating part 302 contacts the bushing's surface material 204 along a contact interface 304. The surface material 204 may experience load forces from the mating part 302. As these forces are applied to the surface material 204 at the contact interface 304, they may be transferred through the surface material 204 to the interlayer 208 at the textured interlayer surface 210.

The solid arrow heads in FIG. 3A represent perpendicular forces transferred from the mating part 302 to the surface material 204 as the bushing substrate 200′ supports the mating part 302. When compared to a non-textured substrate surface, the force is spread out across the larger surface area of the textured interlayer surface 210 as the force is transferred through the surface material 204 to the bushing substrate 200′. In addition, the low areas of the textured interlayer surface 210 may trap or impede the forces from transferring outwards to the ends of the bushing substrate 200′, minimizing deformation or “squeeze out” of the surface material 204.

The solid arrow heads in FIG. 3B represent tangential or lateral forces transferred from the mating part 302 to the surface material 204 as the mating part 302 moves relative to the bushing. When compared to a non-textured substrate surface, the low areas of the textured interlayer surface 210 may trap or impede some of the force from transferring unimpeded through the surface material 204, also minimizing deformation.

To illustrate these forces in a common application, FIG. 4 shows a cross section of an exemplary cylindrical bushing 400 with a base layer 402, an interlayer 408, a surface layer 404, and an exemplary mating shaft 412. The base layer 402 and interlayer 408 are joined along a base surface 406. The interlayer 408 and surface layer 404 are joined along a textured interlayer surface 410. The surface material of the surface layer 404 contacts the mating shaft 412 along a contact interface 414. The mating shaft 412 is supported by the bushing 400 and rotates or axially translates within the bushing 400. In this example, as illustrated with solid arrows, the mating shaft 412 may exert perpendicular and tangential forces on the surface layer 404 along the contact interface 414.

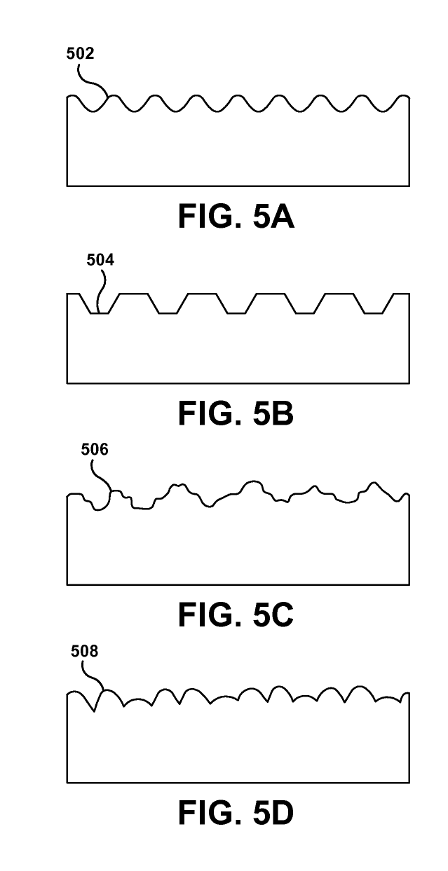

The bushing substrate interface surface may embody any non-flat surface configuration, knurl, pattern, structure, combinations thereof, or the like suitable for the bushing application, the materials involved, and the desired performance. FIGS. 5A-5D show exemplary embodiments of textured bushing substrate interface surfaces 502, 504, 506, and 508. Various textures may be used based upon the base layer material, interlayer material, surface material, mating part material, forces involved, intended reliability, desired maintenance, and any other relevant factors. The textured surface may be configured to mimic the surface structure of expanded metal matrix interlayers, metallically bonded micro-spheres, or any other surface structure beneficial to improving the joining strength and performance properties of the surface material. The exemplary interface surfaces 502, 504, 506, 508 of FIGS. 5A-5D can be incorporated in or directly on the textured base surface 206 of the base layer 202 or the textured interlayer surface 210 of the interlayer 208 as shown in FIGS. 2A and 2B, depending on the bushing substrate configuration.

The textured interface surfaces (for example 502, 504, 506, and 508 of FIGS. 5A-5D) may be formed by any suitable means, such as rolling, stamping, imbedding, blasting, shot peening, or the like. As discussed in more detail below, the textured interface surface, such as the textured base surface 206 of the base layer 202 or the textured interlayer surface 210 of the interlayer 208 as shown in FIGS. 2A and 2B, is formed into the surface after the bushing substrate, such as 200 or 200′, is created. This process is in contrast to known methods of forming the textured interface surface wherein the texture is inherent in the interlayer before the interlayer is attached to the substrate base.

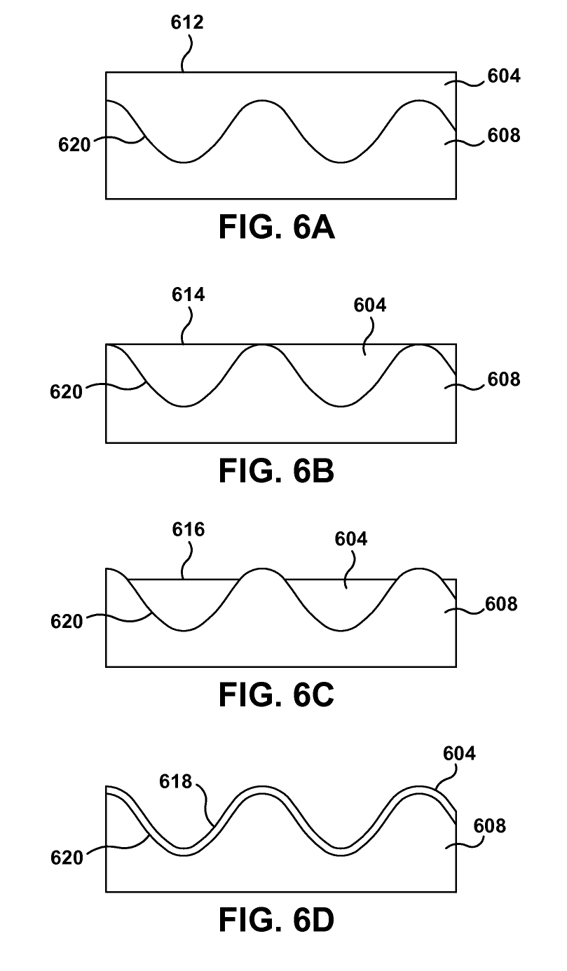

The surface material may also be applied to form any surface layer configuration suitable for the bushing application, the materials involved, and the desired performance. FIGS. 6A-6D show an exemplary interlayer 608 with a surface material 604 applied in exemplary surface layer configurations 612, 614, 616, and 618. Various surface layer configurations may be selected based upon a base layer material (not shown), interlayer 608 material, surface material 604, mating part material, forces involved, intended reliability, desired maintenance, and any other relevant factors. Design considerations may determine the extent of coverage of a textured interlayer surface 620 by the surface material 604. For example, in some bushing applications, it may be desirable for the textured interlayer surface 620 to be even with the top of the surface material 604 layer, as shown in FIG. 6B. Although FIGS. 6A-6D show exemplary embodiments with an interlayer 608, in other embodiments the exemplary surface material 604 configurations may also be applied on the textured base surface 206 of the base layer 202, as shown in FIG. 2A.

The surface material 604 may be applied by any suitable means, such as laminating, spraying, dipping, or the like.

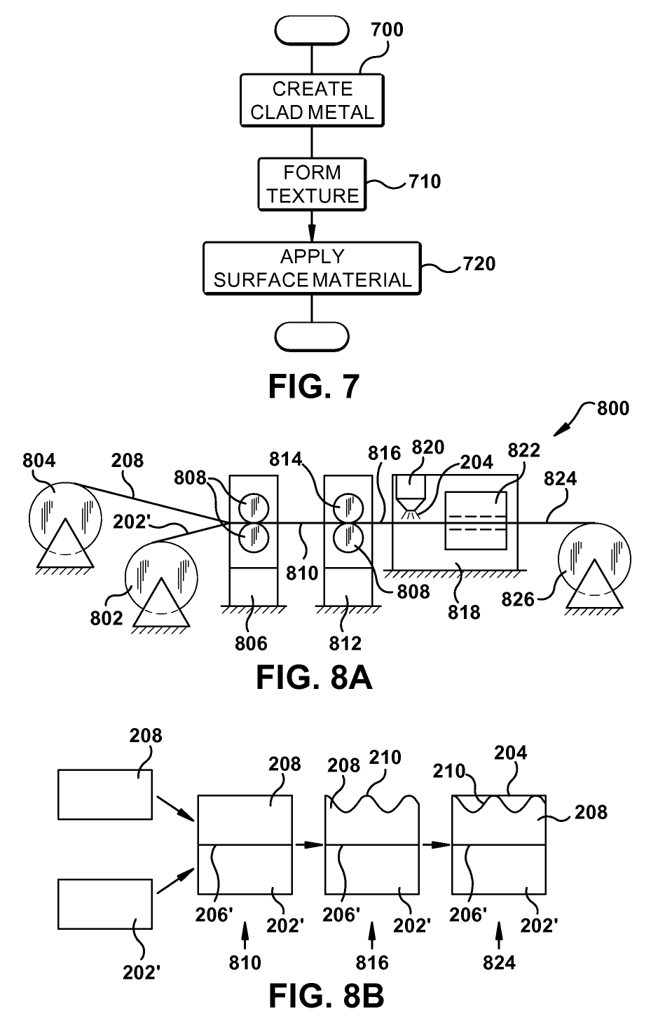

The block diagram in FIG. 7 represents one embodiment of how to make a composite bushing material with the bushing substrate 200′ and surface material 204 of FIG. 2B. Only three steps are illustrated, but any number of functions, operations, processes, steps, or the like may be added to the flow for purposes of enhanced utility, performance, measurement, troubleshooting, and the like. It is understood that all such variations are within the scope of the present invention. The flow of manufacturing the bushing material may begin in block 700 where a clad metal is created. The clad metal may be any suitable combination of at least two metal layers, which may respectively form the base layer 202′ and the interlayer 208. The interlayer 208 is attached to the base layer 202′ along the surface 206′. For example, the base layer 202′ and interlayer 208 may be metallically bonded along the surface 206′, creating the clad metal. Metallic bonding may be a preferred attachment method for high temperature bushing substrate 200′ applications.

After forming the clad metal in block 700, the flow may proceed to block 710, where the textured interlayer surface 210 is formed into the interlayer 208. As described above, the textured interlayer surface 210 may be any textured surface suitable for a particular bushing application. In this manner, the textured interlayer surface 210 is formed into the clad metal after the desired layers of the substrate 200′ are attached together.

After forming the textured interlayer surface 210 in block 710, the flow may proceed to block 720, where the surface material 204 is applied to the textured interlayer surface 210. As described above, the surface material 204 may be applied in any configuration suitable for a particular bushing application.

The illustration in FIG. 8A represents one embodiment of a system 800 that may be used to manufacture the composite bushing material of FIG. 2B, including the bushing substrate 200′. Although FIG. 8A shows a specific order of devices and executing processes, the order of the devices and process execution may be changed relative to the order shown. Also, two or more devices or processes shown in succession may be executed concurrently or with partial concurrence. Certain devices and processes also may be omitted. In addition, any number of devices, equipment, processes, operations, steps, or the like may be added for purposes of enhanced utility, performance, measurement, troubleshooting, and the like. For convenience, the exemplary devices are shown as part of a continuous production process, but the devices may be arranged and the processes may be performed independently without a connected flow. It is understood that all such variations are within the scope of the present invention.

FIG. 8A shows the exemplary system 800 as an exemplary continuous feed process for manufacturing the bushing material including the bushing substrate 200′. A base layer reel 802 may hold and feed a strip of the base layer 202′. Similarly, an interlayer reel 804 may hold and feed a strip of the interlayer 208. The strip of the base layer 202′ and the strip of the interlayer 208 may be concurrently unwound and fed through a bonding device 806. The base layer 202′ and the interlayer 208 are aligned such that their respective surfaces make contact along the surface 206′, as shown in FIG. 2B. The bonding device 806 may, for example, be a pressure roller device including flat rollers 808 that apply pressure on opposite sides of the base layer 202′ and the interlayer 208. Using the flat rollers 808, the bonding device 806 may exert a pressure sufficient to create a metallic bond between the base layer 202′ and the interlayer 208 along the surface 206′, creating a clad metal 810.

The clad metal 810 may be fed through a texturing device 812. The texturing device 812 may, for example, be a pressure roller device including a flat roller 808 and a textured roller 814 that may be embossed with a pattern. The pattern on the textured roller 814 is the complementary shape of the desired textured interlayer surface 210 pattern. Using the flat roller 808 and the textured roller 814, the texturing device 812 may be used to exert a pressure sufficient to form the desired textured interlayer surface 210 into the interlayer 208 side of the clad metal 810, forming a textured clad metal 816.

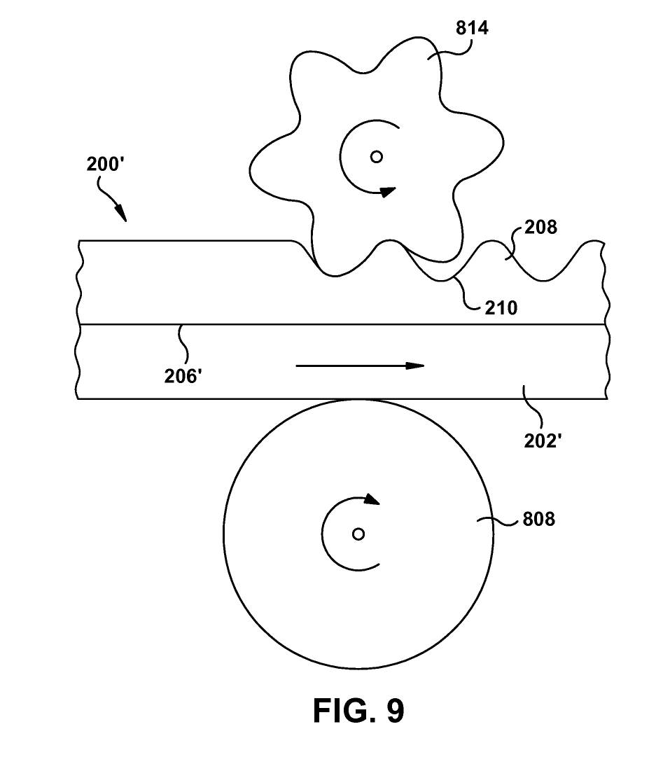

FIG. 9 is an illustration showing an exemplary flat roller 808 and textured roller 814 forming the textured interlayer surface 210 into the interlayer 208 of the bushing substrate 200′. The solid arrows indicate the direction of travel of the flat roller 808, the textured roller 814, and the bushing substrate 200′. As the bushing substrate 200′ is fed through the texturing device 812, the pattern of the textured roller 814 forms the desired textured interlayer surface 210.

Returning to FIG. 8A, the textured clad metal 816 may be fed through a surfacing device 818. The surfacing device 818 may, for example, be a coating device including, for example, a sprayer 820 and a curing apparatus 822. The sprayer 820 may be used to apply the surface material 204 to the textured interlayer surface 210 of the textured clad metal 816. The curing apparatus 822 may be used to cure the surface material 204, yielding a surfaced clad metal 824.

In some applications, the surfaced clad metal 824 may then be fed onto a bushing material reel 826. In other applications, the surfaced clad metal 824 may be cut by a cutting apparatus (not shown) into sheets having any desired shape and size. The surfaced clad metal 824 may be the exemplary composite bushing material of FIG. 2B, which includes the bushing substrate 200′. The block diagram elements 700, 710, 720 of FIG. 7 may be related to their corresponding exemplary devices and processes of the exemplary system 800 shown in FIG. 8A. Block 700 (create clad metal) may include the base layer reel 802, the interlayer reel 804, and the bonding device 806, resulting in the manufacture of the clad metal 810. Block 710 (form texture) may include the texturing device 812, resulting in the manufacture of the textured clad metal 816. Block 720 (apply surface material) may include the surfacing device 818, resulting in the manufacture of the surfaced clad metal 824.

FIG. 8B shows cross sections of the material layers included in the exemplary composite bushing material of FIG. 2B in different stages as it passes through the exemplary continuous feed system 800 of FIG. 8A. The output of the bonding device 806 is shown as the clad metal 810; the output of the texturing device 812 is shown as the textured clad metal 816; and the output of the surfacing device 818 is shown as the surfaced clad metal 824.

Although embodiments of the invention have been shown and described, it is understood that equivalents and modifications will occur to others in the art upon the reading and understanding of the specification. The present invention includes all such equivalents and modifications.

We claim:

1. A method of manufacturing a bushing substrate, comprising the steps of:
first making the bushing substrate; then
forming a texture into a surface of the bushing substrate, wherein
forming the texture results in any non-flat surface on the bushing substrate.

2. The method of claim 1, wherein the bushing substrate is a clad metal comprising a base layer and an interlayer.

3. The method of claim 2, wherein the clad metal is formed by applying high pressure between the base layer and the interlayer, and wherein the high pressure creates a metallic bond between the base layer and the interlayer.

4. The method of claim 3, wherein the high pressure is applied mechanically.

5. The method of claim 3, wherein the high pressure is applied kinetically.

6. The method of claim 2, wherein the base layer comprises a high strength material, and the interlayer comprises a high ductility material.

7. The method of claim 6, wherein the high strength material is selected from the group consisting of steel and titanium, and the high ductility material is selected from the group consisting of bronze, brass and aluminum.

8. The method of claim 1, wherein forming the texture includes rolling the texture into the surface of the bushing substrate.

9. The method of claim 1, wherein forming the texture includes stamping the texture into the surface of the bushing substrate.

10. The method of claim 1, further comprising the step of applying a surface material onto the textured surface of the bushing substrate.

11. A bushing substrate manufactured by a method, the method comprising the steps of:
first making the bushing substrate; then
forming a texture into a surface of the bushing substrate, wherein
forming the texture results in any non-flat surface on the bushing substrate.

12. A bushing substrate manufactured by the method of claim 11, wherein the bushing substrate is a clad metal comprising a base layer and an interlayer.

13. A bushing substrate manufactured by the method of claim 12, wherein the clad metal is formed by applying high pressure between the base layer and the interlayer, and wherein the high pressure creates a metallic bond between the base layer and the interlayer.

14. A bushing substrate manufactured by the method of claim 13, wherein the high pressure is applied mechanically.

15. A bushing substrate manufactured by the method of claim 13, wherein the high pressure is applied kinetically.

16. A bushing substrate manufactured by the method of claim 12, wherein the base layer comprises a high strength material, and the interlayer comprises a high ductility material.

17. The method of claim 16, wherein the high strength material is selected from the group consisting of steel and titanium, and the high ductility material is selected from the group consisting of bronze, brass and aluminum.

18. A bushing substrate manufactured by the method of claim 11, wherein forming the texture includes rolling the texture into the surface of the bushing substrate.

19. A bushing substrate manufactured by the method of claim 11, wherein forming the texture includes stamping the texture into the surface of the bushing substrate.

20. A composite bushing comprising a bushing substrate manufactured by the method of claim 10 and a surface material attached to the textured surface of the bushing substrate.
